(19) United States
(12) Patent Application Publication
(10) Pub. No.: US 2023/0220193 A1
(43) Pub. Date: Jul. 13, 2023

(54) Water-based Lignin-Particle-Epoxy Surface Coatings, Thermosets and Adhesives

(71) Applicant: Aalto University Foundation sr, Aalto (FI)

(72) Inventors: Nina Forsman, Aalto (FI); Monika Österberg, Aalto (FI); Alexander Henn, Aalto (FI)

(21) Appl. No.: 17/927,938

(22) PCT Filed: May 28, 2021
(86) PCT No.: PCT/FI2021/050389

§ 371 Date: Nov. 28, 2022

(30) Foreign Application Priority Data
May 28, 2020 (FI) 20205555

(51) Int. Cl. C08L 63/00; C08H 7/00; C08L 97/00; C08J 3/00; C09D 163/00; C09D 197/00; C09D 5/02; C09D 7/20; C09D 7/80; C09J 163/00; C09J 197/00; C09J 5/06

(52) U.S. Cl. CPC C08L 63/00; C08H 6/00; C08J 3/005; C08L 97/005; C09D 5/02; C09D 7/20; C09D 7/80; C09D 163/00; C09D 197/005; C09J 5/06; C09J 163/00; C09J 197/005; C08J 2363/00; C08J 2397/00; C08J 2463/00; C08J 2497/00; C08L 2201/50; C08L 2205/06; C08L 2205/18

(57) ABSTRACT

According to an example aspect of the present invention, there is provided a composition comprising colloidal lignin particles and an epoxy compound.

### FIELD

The present invention relates to a composition comprising an epoxy compound and colloidal lignin particles. Particularly, the present invention relates to surface coatings, adhesives and thermosets comprising the composition. Methods of forming the composition and methods of forming and applying the surface coatings and adhesives are also disclosed.

### BACKGROUND

Epoxy coatings and adhesives are generating increasing attention for their strength and high quality. Compared to other existing solutions, epoxy-based thermosets and coatings are highly resistant towards heat, solvents, mechanical force, abrasion, and structural weakening [1]. Epoxy-materials are manufactured by the reaction of two molecules, one of which has at least two epoxide-groups, and the other of which contains at least two suitable reactive groups, such as hydroxyl- or amine groups. If more than two sites are available on the reactive- or epoxy-group containing substance, the polymer becomes branched and therefore increasingly resistant towards stress (heat or other external forces) and more rigid. If the polymer chain of the epoxy-compound is long and contains few epoxide groups, the cured epoxy becomes more flexible and soft. The properties of epoxy-based polymers are therefore customizable by the choice of epoxy components and their ratios [1]. Bisphenol-A (BPA) is a widely used base-component for epoxidation reactions and one of the most produced chemicals in the world. It can be epoxidized, by grafting epoxide structures onto its hydroxyl groups. The result of this reaction is bisphenol-A diglycidyl ether (BADGE), which is capable of polymerizing together with BPA or other diols and other suitable materials. Epoxies are currently used as surface coating in marine environments, pipework, food packaging, and floorings, and as thermoset material in various applications, like in automotive and aerospace transport, construction, electronics, energy, and sports, and even in state-of-the-art biomedical applications [1].

Thermosets are in general highly cross-linked and thus heat-, abrasion-, and chemical-resistant material. Epoxy resins are a form of thermosets, even when used as surface coating or adhesive. Most thermosets are however so stable, that they cannot be recycled properly due to their inability to re-mould in elevated temperatures. The only way of discarding most thermosets is thus by incineration. As most thermoset materials are made from fossil-based raw-material, incineration leads to the generation of new carbon dioxide in the atmosphere, thus increasing the amount of free-cycling carbon dioxide, which should of course be avoided. The use of thermoset materials should consequently not be used in applications where a non-thermoset material could be used. Thermosets are nevertheless needed in many applications where highly resistant materials are required. Fully biobased thermosets would not increase the amount of free-cycling carbon dioxide in the atmosphere if discarded by incineration and can be designed to possess the same stability as fossil-based thermosets. Therefore, a shift towards biobased thermosets would be highly desired from an environmental perspective.

There are other major drawbacks in existing epoxy resins, as the most widely used (if not all) epoxy resin components have a significant degree of toxicity. Both bisphenol-A (BPA) and its epoxide form, bisphenol-A diglycidyl ether (BADGE) are harmful for mammals and aquatic life but are still widely used [2-5]. BPA and BADGE have shown to be endocrine disruptors and reach humans when leached into food from its packaging, commonly canned food. Recent studies have shown that doses as small as 5 mg/kg can have detrimental effects on mammals in the form of reduced sperm production in males and increased risk of breast cancer in females and contribute to a wide variety of disorders such as type II diabetes, urogenital disorders in male babies, attention-deficit hyperactivity disorder, and more [2,4,6]. Two years after a declaration about such findings by the National Toxicology Program in 2008, Canada declared it harmful for human health and the environment and both Canada and Denmark banned the use of BPA in plastic containers for babies and young children respectively. Later in 2011, the whole European Union followed the ban [5]. The United States’ Food and Drug Administration (FDA) followed suit as well in 2012 at the request of manufacturers [2]. Therefore, although the epoxy-market is increasing in size, it is threatened by the adverse health effect of the materials needed for their manufacture. Another wider ban is expected from the European Union for 2020, where its use in household plastics and other items would be limited [7]. It is important to note that not only specifically BPA and BADGE can have adverse effects, but many other substances with similar structures as well [5].

Epoxy-polymerization reactions, also known as curing reactions, do not proceed to completion without additional external energy in most cases, which is why heat, radiation, or some amount of curing initiator is needed to start and/or complete the reaction. In applications where heat cannot be provided, reactive curing initiators are used. Nitrogen-, or more specifically amine-based curing agents are effective for this purpose and can be in liquid or solid state at room temperature. The liquid-state amines are often highly volatile, alkaline, and reactive. Because of this, the amines in laminating and adhesive industries are usually modified by e.g. oxidation to become less volatile and irritating [8]. The processes and raw materials used are nevertheless hazardous and toxic. A sufficient amount of curing agent is important concerning safety, as uncured epoxy-components are regarded as more hazardous than unreacted excess curing agent [9]. The toxicity of the curing agent is therefore significant, as the excess curing agent will, in consequence, be the component to leach out of a cured resin. However, the user is not the only one who may be at risk as there are multiple steps in the preparation of readily usable products where personnel can get into contact with both components. The hazards coupled with unreacted amines also limit the applicability of epoxy coatings and thermosets in general. In plastics and composites, plasticisers soften the matrix by providing more free space. This allows more movement between polymer chains, but would also allow for the excess, unreacted amines to leach quicker. Since curing initiators are also toxic, epoxy resins are limited to some degree from using additives with plasticizing effect [8,9].

Another drawback of epoxy surface coatings regarding function is poor breathability, which can induce build-up of moisture and damage to the coated material and the coating itself. Damaged coatings can often not be repaired and thus have to be completely removed, which is a highly difficult and often costly task, especially for private individuals.

Although the utilization of biobased materials does not in itself solve the technical issues that widely used fossil-based epoxies face, it brings many benefits both from local (both business and community) and global perspectives. As today’s people are quite well informed about the destructively negative large-scale environmental impacts caused by the wide use of fossil-based materials, the social acceptance of a bio-based epoxy product is significantly better than for fully synthetic and fossil-based ones. Hence, the use of biobased materials is worth striving for in all applications where they could be used. As the epoxy market is still relatively new and growing, it would be desirable to change its course from fossil- to biobased early. The most commonly used epoxy formulations are not biobased, although there are some biobased solutions. WO2017096187A1 discloses a method for preparing and using biobased epoxy formulations from plant-derived fatty acids by reactions with alicyclic oxiranes [10]. CN109467677A and CN109503644A discloses similar methods for preparation and use of eugenol-based epoxies [11,12].

Although fatty-acids and plant-derived compounds of the like are environmentally friendly and suitable for epoxy applications, lignin is a suitable candidate as well, especially since it is extremely abundant and remains underutilized. CN109181612A discloses a method for preparation of a biobased adhesive containing mostly starch and a small part of lignosulfonates together with an adhesive component, which can be an epoxy compound [13]. US2015329753A1 discloses a method for the preparation of an adhesive from lignin and an epoxy compound [14]. The use of raw lignin is limiting, as it is very difficult to spread evenly and can therefore not be used as a protective surface coating.

Still, lignin-based surface coatings have been developed by some. CN109701462A prepared dopamine-coated lignin particles as a surface coating for ultraviolet- and weathering protection [15]. WO2015044893A1 disclosed methods for the preparation and use of lignin-based epoxy compounds and epoxy-polymerized lignin for surface coatings. The epoxidation of lignin is disclosed but is dependent on hazardous organic solvents additional to epichlorohydrin to work [16]. KR20150097554A discloses methods for the preparation of surface coatings of polymerized lignin, including epoxy-polymerized lignin[17]. US2018312625A1 discloses a method for the preparation and use of lignin in polyurethane adhesives and applications of the like [18]. US10544545B2 discloses a method for the preparation and application of lignin-based surface coatings using acid- and heat-treatments [19]. WO2014021887A1 discloses a method for the preparation and use of epoxy-polymerized lignosulphonatemethylol compounds, being lignin reacted with formaldehyde or glyoxal, for adhesives, coatings, and applications of the like [20].

### SUMMARY OF THE INVENTION

The invention is defined by the features of the independent claims. Some specific embodiments are defined in the dependent claims.

According to a first aspect of the present invention, there is provided a composition comprising colloidal lignin particles and an epoxy compound.

According to a second aspect of the present invention, there is provided a surface coating comprising a composition of colloidal lignin particles and an epoxy compound.

According to a third aspect of the present invention, there is provided an adhesive comprising a composition of colloidal lignin particles and an epoxy compound.

According to a fourth aspect of the present invention, there is provided method for manufacturing a composition comprising colloidal lignin particles and an epoxy compound. The method comprises the steps of providing colloidal lignin particles, providing an epoxy containing compound, and mixing the epoxy compound and the colloidal lignin particles to form a composition.

According to a fifth aspect of the present invention, there is provided a method of coating a surface comprising the steps of applying a composition comprising colloidal lignin particles and an epoxy compound, said composition being obtainable by the method according to the fourth aspect of the present invention, to a surface to be coated and heating the coated surface to initiate a curing reaction.

According to a sixth aspect of the present invention, there is provided a method of coating a surface comprising the steps of applying colloidal lignin particles to a surface to be coated and applying an epoxy compound to the surface to be coated in a separate step.

According to a seventh aspect of the present invention, there is provided a method of adhering a surface of a first substrate to a surface of a second substrate comprising the steps of applying a composition according to any the first, second or third aspect obtainable by a method according to the fourth aspect to coat a surface of a first substrate, pressing the coated surface of the first substrate with a surface of a second substrate, and heating the pressed material to a temperature up to 350° C.

According to an eight aspect of the present invention, there is provided a method of stabilizing CLPs

According to a ninth aspect of the present invention, there is provided an epoxidised lignin, a method for producing it and uses as an epoxy compound for adhesives and coatings.

According to a tenth aspect of the present invention, there is provided a thermoset.

According to an eleventh aspect of the present invention, there is provided a method of forming a thermoset.

### BRIEF DESCRIPTION OF THE DRAWINGS

FIG. 1 presents AFM images of thick coatings in various GDE/CLP ratios.

FIG. 2 shows SEM images of a thick cured mixture at the GDE/CLP ratio 0.65 g/g.

FIG. 3 presents SEM images of a cured mixture on wood.

FIG. 4 presents the average mass change in all samples and in four commercially available references

FIG. 5 shows the abrasion resistance of cured coatings with different ratios of GDE/CLP measured by the ASTM-D4060 standard method.

FIG. 6 shows the effects of curing time in 105° C. on the abrasion resistance of a coating with GDE/CLP ratio of 0.52 g/g, measured following the ASTM-D4060 standard method.

FIG. 7 shows water contact angles of wood pieces coated with coatings of different ratios of GDE/CLP and thicknesses of the coating. The thicknesses are 12.4, 8.9 and 6.9 g(CLP)/m2 and decrease from left to right. The referential coatings were coated according to the manufacturers’ respective instructions and recommendations.

FIG. 8 displays the solvent and stain resistance of a coating with the GDE/CLP ratio of 0.65 g/g. Coffee, wine and, acetone was dropped within circles 1, 2 and, 3 respectively.

FIG. 9 shows pieces of birch plywood made using an adhesive consisting of GDE and CLP in the respective ratio 0.65 g/g.

### EMBODIMENTS

### Definitions

The terms colloidal lignin particle (hereafter referred to as CLP, plural CLPs), spherical lignin particle, lignin particle or lignin nanoparticle refers to spherical particles of solid unmodified kraft lignin prepared as described in WO2019081819A1 [21] but spherical lignin particles prepared by other methods can also be used.

The particles may be hybrids, meaning particles whose main component is lignin, but can be comprised of other substances as well, like fatty acids, proteins, polysaccharides, or other polymeric or molecular substances. The particles may also be infused with ions, for example, silver, to gain anti-microbial properties. The particles may also be coated with other polymers or substances to alter their surface charge.

Particles with positive charge are consequently also possible. The molar amount of various forms of hydroxyl groups per mass of the particles can vary, although higher amounts than 4 mmol/g are preferable. The term “epoxy compound” refers to any compound containing one or more epoxide groups (cyclic three atom ether), except for epoxidized lignin (hereafter referred to as EL). Examples of epoxy-compounds are bisphenol-A diglycidyl ether, glycerol diglycidyl ether, Novolaks and, others.

Unless otherwise stated or described, mixtures of dry or aqueously dispersed CLPs and epoxy compounds (here including EL) in any form are hereafter referred to as “mixtures” in contexts of applying mixtures of CLP dispersions and solubilized or phase-separated epoxy compounds. When referring specifically to CLPs or the epoxy compound within a mixture of the two compounds and not the mixture itself, the term “component” will be used hereafter unless otherwise indicated.

The term “curing” and “cured” in this context refer to the ongoing (=curing) and finished (= cured) process of the formation of covalent links within, on the surface of, and between the surfaces of CLPs due to the reaction of the hydroxyl groups in/on the CLPs with the epoxy-groups on the epoxy compound. Curing can take place at room temperature (20 - 25° C.), at elevated temperatures up to 350° C., or conditions of elevated radiation of visible light, infrared light and ultraviolet light with energies up to 100 000 W/m². The humidity in the surrounding air during the curing can be altered from 0 - 100 % relative humidity (RH). The time of the curing process can vary, depending on the conditions.

Unless specifically stated or described otherwise, the term “surface” or “surfaces”, when referring to a “surface” onto which the invention is applied to, refers to any type of rigid, bendable or flexible surfaces onto which the invention can be applied. Examples of these are any type of wood, textiles, metals, metal alloys or other types of metallic composites, plastics or plastic-like composites, composite materials unlike plastics, glass and glass-like materials, concrete and concrete-like material, ceramics and ceramic-like materials, stone, and stone-like materials, and materials of the like.

The present invention relates to the use of combinations of colloidal lignin particles, (abbreviation: CLP, plural CLPs) and epoxide-group(s) containing components as adhesives, surface coatings, thermosets and other applications of the like and combinations thereof. The present invention further relates to the use of CLPs as a raw material for grafting epoxide groups onto lignin, which can then be used as an epoxy-component with CLPs for fully lignin-based adhesives, thermosets, and surface coatings. Additionally, the present invention relates to the combination of the previously mentioned embodiments, where epoxy groups are grafted onto epoxy-cross-linked CLPs, resulting in epoxy-based CLPs. By means of the present invention it has surprisingly been found that colloidal lignin particles enable the production of surface coatings, adhesives and, thermosets in aqueous dispersions without alkalinity, acidity, or traces of organic solvents. The resulting process is safer and more customer-friendly than the existing solutions. The product itself is highly durable and possess properties that could not be achieved using any other process or materials, and is, therefore, a big step forward in the field of epoxy coating and thermoset and biomaterials technologies.

The invention belongs to the field of technical use and preparation of nanomaterials. The invention can be used as a surface coating or an adhesive for all types of surfaces, and as a thermoset material. The invention is resistant to water, various solvents (such as acetone, tetrahydrofuran, toluene, ethanol, acids, bases, etc.), commodity liquids (e.g. coffee, turmeric, wine), as well as resistant to physical attacks like heat, UV-light, and abrasion and can be customized according to the application. Despite the good resistance to liquids, the invention embodied as a coating still breathes well, in contrast to commercial epoxy coatings. The breathability and general penetrability of gases can be adjusted according to different applications and their requirements. The invention is therefore applicable in a broad range of fields and applications, all from industrial to everyday use.

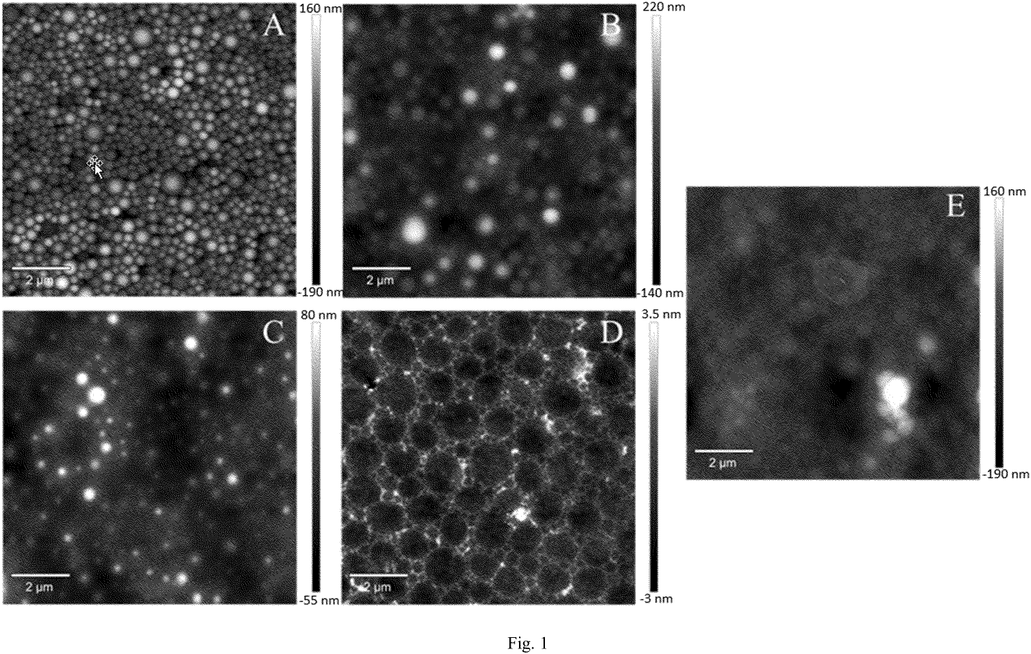

FIG. 1 shows atomic force microscopy images of CLPs cured using glycerol diglycidyl ether (GDE) in accordance with at least some embodiments of the present invention in the GDE/CLP ratios A) 0 g/g, B) 0.39 g/g, C) 0.65 g/g and D) 0.78 g/g and E) uncontrolled ratio by tapping dry lignin particles with a dust-free paper moist with glycerol diglycidyl ether.

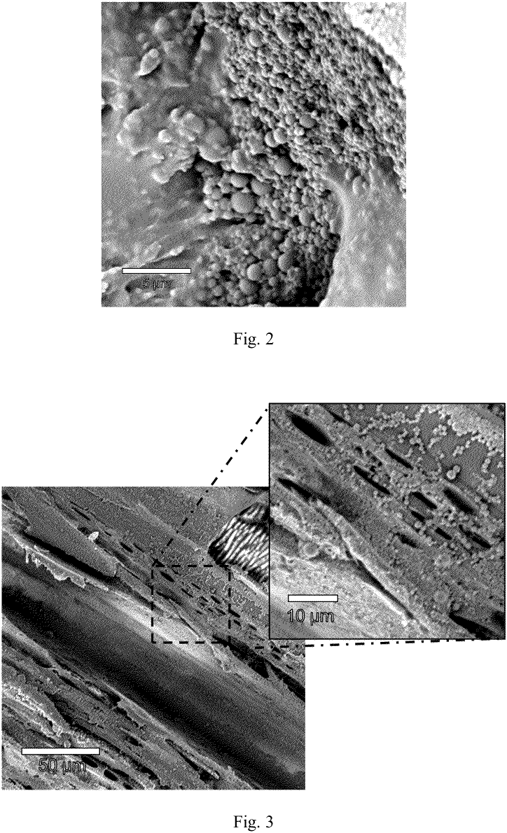

FIG. 2 shows a scanning electron microscopy image of a thick surface coating of GDE and CLPs in accordance with at least some embodiments of the present invention in the respective ratio 0.65 g/g cured in 1 h at 105° C.

FIG. 3 shows a scanning electron microscopy image of a wooden surface coated with 12.4 g(CLP)/m2 of a coating in accordance with at least some embodiments of the present invention, with the GDE/CLP ratio 0.52 g/g cured for one hour at 105° C., where the CLPs are clearly distinguishable on the wood surface.

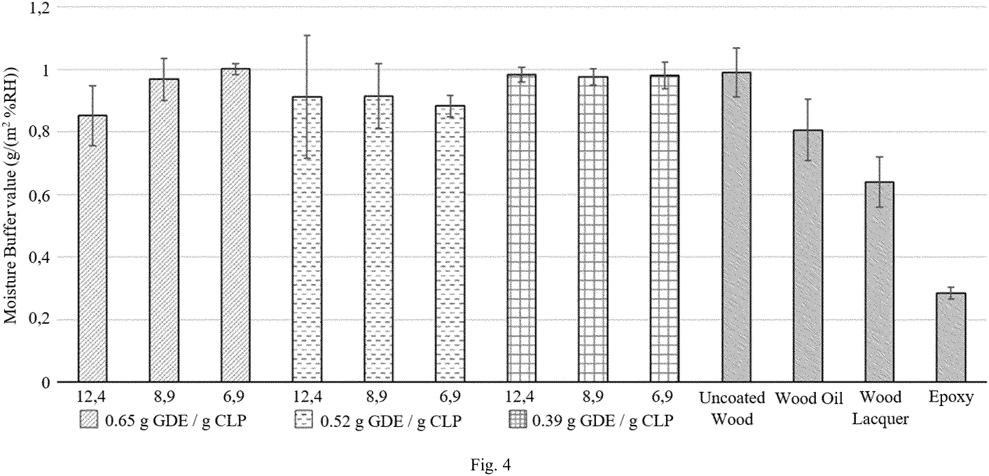

FIG. 4 shows the results of breathability tests of wood pieces coated with coatings of different ratios of GDE/CLP and thicknesses of the coating in accordance with at least some embodiments of the present invention. The thicknesses are 12.4, 8.9, and 6.9 g(CLP)/m2 and decrease from left to right. The commercial coatings used for comparison were coated according to the manufacturers’ respective instructions and recommendations.

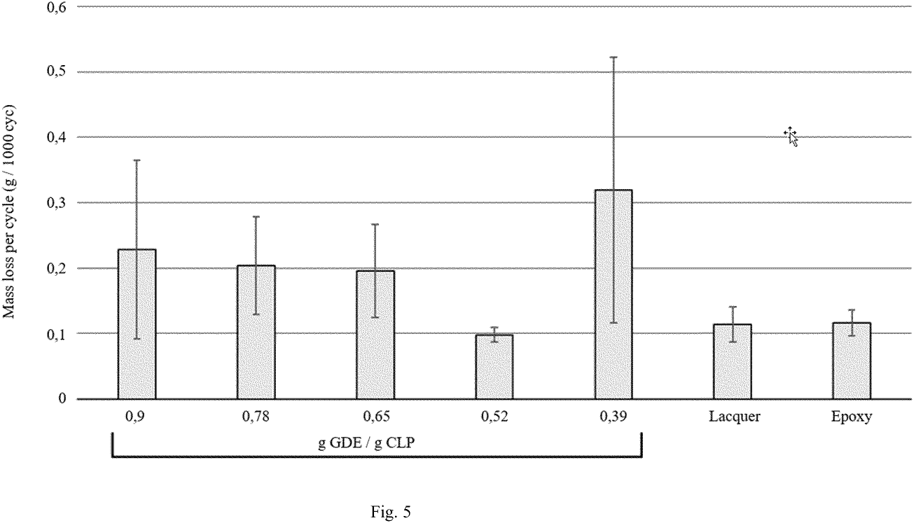

FIG. 5 shows the abrasion resistance of cured coatings with different ratios of GDE/CLP measured by the ASTM-D4060 standard method in accordance with at least some embodiments of the present invention. FIG. 5 illustrates the mass loss per 1000 cycles of abrasion.

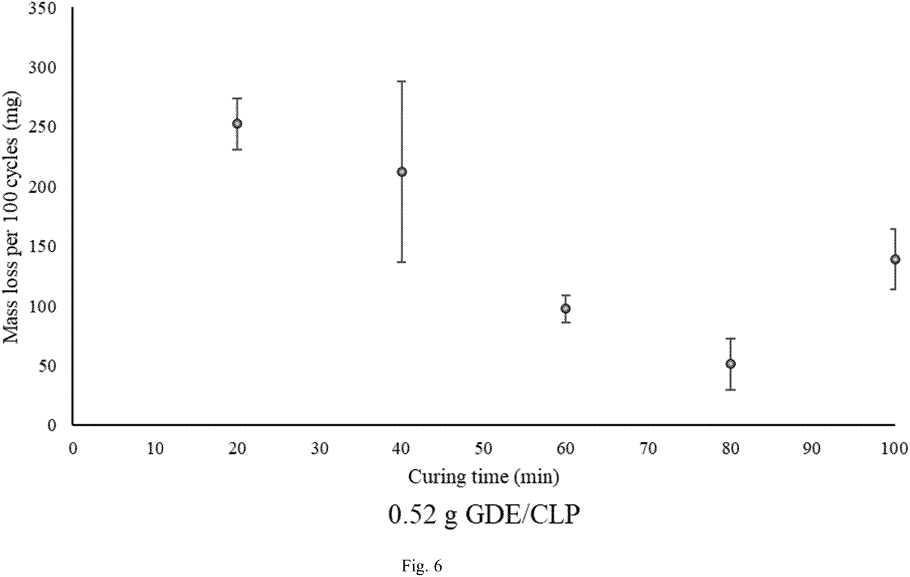

FIG. 6 shows the effects of curing time in 105° C. on the abrasion resistance of a coating in accordance with at least some embodiments of the present invention with GDE/CLP ratio of 0.52 g/g, measured following the ASTM-D4060 standard method. FIG. 6 illustrates the mass loss per 1000 cycles of abrasion

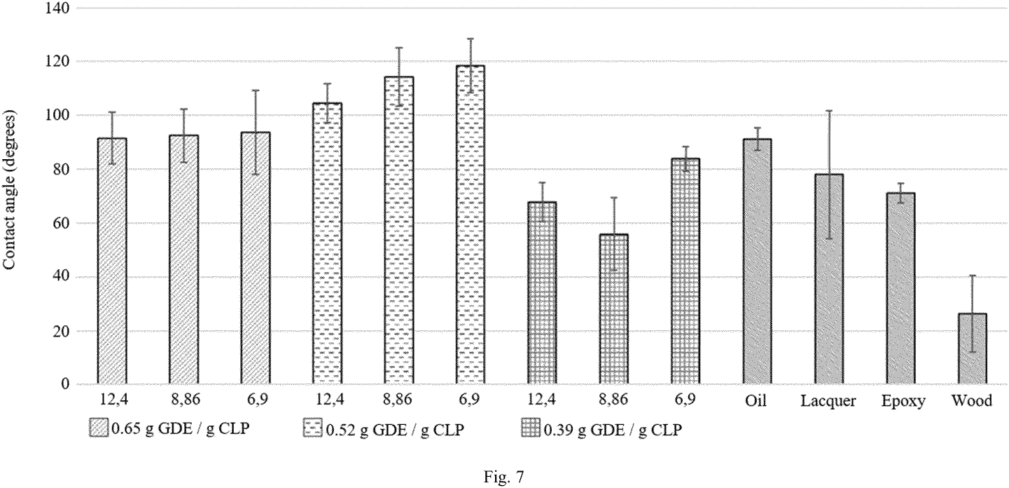

FIG. 7 shows water contact angles of wood pieces coated with coatings of different ratios of GDE/CLP and thicknesses of the coating in accordance with at least some embodiments of the present invention. The thicknesses are 12.4, 8.9 and 6.9 g(CLP)/m2 and decrease from left to right. The referential coatings were coated according to the manufacturers’ respective instructions and recommendations.

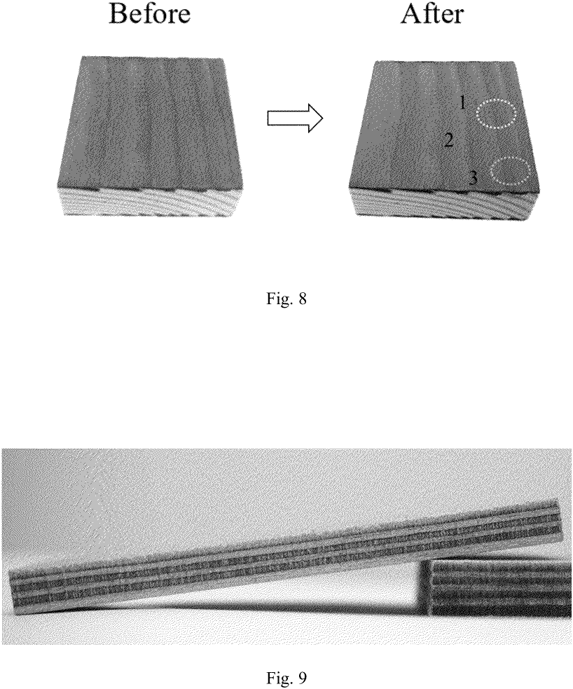

FIG. 8 displays the solvent and stain resistance of a coating in accordance with at least some embodiments of the present invention with the GDE/CLP ratio of 0.65 g/g. Coffee, wine and, acetone was dropped within circles 1, 2 and, 3 respectively.

FIG. 9 shows pieces of birch plywood made using an adhesive in accordance with at least some embodiments of the present invention consisting of GDE and CLP in the respective ratio 0.65 g/g.

As described above the embodiments of the invention relate to a composition. In an embodiment the composition comprises colloidal lignin particles and an epoxy compound. In one embodiment the colloidal lignin particles are dry. In a preferred embodiment the colloidal lignin particles are dispersed in an aqueous dispersion. The lignin used can be from multiple sources and can be isolated using various methods, preferably by a method that retains or increases the amount of hydroxyl groups in the lignin.

The concentration of lignin within the CLP dispersion can be as high as desired, as long as the particles are in a dispersed state, usually up to 50 wt.%, but preferably between 5 - 20 wt.% to avoid formation of aggregates which happens quicker when highly concentrated dispersion are used. Thus, in an embodiment the aqueous dispersion has a concentration of colloidal lignin particles up to 50 wt. %., preferably the aqueous dispersion has a concentration of colloidal lignin particles in the range of 5 to 20 wt. %.

In one embodiment, it is preferable that the lignin dispersion contains no volatile compounds. The lignin dispersion may, however, contain organic volatile solvents for lignin and/or the used epoxy compound(s) in embodiments where such compounds are purposeful. Thus in one embodiment the composition further comprises one or more organic solvents, suitably organic volatile solvents, preferably the composition further comprises one or more organic solvents selected from the group consisting of ethanol, tetrahydrofuran and acetone.

In embodiments where organic volatile solvents in the aqueous phase are purposeful, their amount can be as high as necessary as long as the CLPs do not dissolve. The limit therefore depends on the temperature and solvent, although the water content should usually be above 70 vol.% in regard to the other solvents to avoid CLP dissolution. Thus, in an embodiment water comprises more than 70 vol% in relation to the one or more organic solvents.

In an embodiment, aqueously dispersed CLPs or dry CLPs can be combined with any epoxy compound. In one embodiment the epoxy compound is a molecule or polymer containing two or more epoxide groups in its structure. In a preferred embodiment the CLPS are combined with a somewhat hydrophilic compound, suitably glycerol diglycidyl ether, which induces covalent inter- and intraparticle cross-linking and linking. In the embodiment, the process of combining the components can be by adding the CLP component to the epoxy component, or the other way around. Thus, in an embodiment the epoxy compound is a hydrophilic compound, preferably the epoxy compound is glycerol diglycidyl ether. The components may be dissolved in or mixed within any medium, as long as the CLPs remain as intact particles. The epoxy compound may also be pure before combining the components. When dried and cured in 25 - 350° C., the particles preferably form one or multiple layer(s) of linked and cross-linked particles and consequently networked groups of particles on the surface onto which the coating is applied (FIG. 2 and FIG. 3). The mass ratio of epoxy to CLP can vary, but should preferably be such that the molar ratio of epoxy groups to hydroxyl groups is preferably between 1.5:1 - 0.2:1, particularly between 1.5:1 - 0.6:1. As the hydroxyl-group-containing compound, the CLPs, are safe and biocompatible, the molar epoxy/CLP ratio should not be higher than 1.5:1 (unless additional reactive components which can react with epoxide-groups are added), as excess epoxy would not improve mechanical properties of the cured material, only increase toxicity.

Indeed one of the tremendous benefits of embodiments is the increased safety [22,23]. The epoxy group reacts in a 1:1 ratio with hydroxyl groups on the CLPs, which means that half or even about three-quarters of the components of the invention are completely safe and of course environmentally friendly, in contrast to most existing solutions. If amine-based curing agents are preferred (for applications that cannot require heat), the amount of these can consequently be decreased. The use of raw lignin as such and not as CLPs gives significantly different properties and is limited to a high degree. The limitations that non- particulate lignin faces are due to its poor water solubility. Using lignin suspensions for applications like surface coatings result in uneven coatings that would neither be attractive in a competitive market nor properly functional. Additionally, many types of lignin, including kraft lignin, are highly water-evading, and thus draws cross-linkers to itself too quickly. This results in clumps and problematically viscous mixtures that cannot be properly spread. The use of raw lignin for attractive surface coatings is hence not possible or highly limited. Therefore, the use of colloidal lignin particles is significantly different compared to the use of native lignin, and technically extremely beneficial.

In embodiments the mechanical properties are preferably customized and modified with the addition of plasticisers. In an embodiment the composition comprises a plasticiser or plasticisers, such as glycerol, starch, and varying polyols and oligosaccharides. In a further embodiment, mechanical properties are customized by varying the epoxy compound e.g. by optimizing the spacer length.

Compositions according to embodiments can be used in various applications depending on the amount of CLPs in the composition. In one embodiment the composition has a concentration of colloidal lignin particles of 10 - 20 wt. % of the composition. Such a composition may be suitable for use a surface coating. In an embodiment the composition is suitable for use as a surface coating for rigid surfaces or bendable surface, preferably surfaces such as as concrete, stone, wood, plywood, metal, plastic-like films, and textiles. In a particular embodiment the composition is suitable for a protective surface coating, providing surfaces with protection from e.g. stains, abrasions etc.

In a further embodiment the composition has a concentration of colloidal lignin particles of 30 wt.% or more of the composition, typically in the range of 50 to 80 wt. % of the composition, preferably 70 wt. % of the composition. Such a composition may be suitable for use as an adhesive for concrete, stone, wood, plywood, metal, plastic-like films, and textiles.

In a further embodiment, the composition comprises one or more curing initiators or additives, e.g. to initiate curing of an adhesive comprising the composition or to initiate curing of a surface coating comprising the composition.

The lignin particles can be of varying size and can be manufactured using various processes, although spherical particles are preferable. Thus, in an embodiment the colloidal lignin particles are spherical. Spherical particles in an embodiment, naturally have a regular structure which means reactions and interactions are more predictable and more uniform in their nature. In a typical embodiment, spherical lignin particles have a greater number of hydroxyl particles on their surfaces than non-spherical particles whereby spherical particles, in an embodiment, have an improved capacity for curing. In a further embodiment the colloidal lignin particles have a diameter in the range of 10 - 2000 nm, preferably 100 - 1500 nm, suitably 500 - 1000 nm, for example the particle diameter of the CLPs can be between 10 - 1000 nm or 300 - 500 nm. Particles with a smaller diameter, have a higher aspect ratio and are positioned closer to each other thereby providing in an embodiment an even coating on a surface with a relatively thin layer of CLPs, coating or adhesive. Particles with a larger diameter allows for an embodiment in which the amount of lignin compared to the amount of epoxy is greater, resulting in greater surface roughness which in turn increases the hydrophobicity of the coating or adhesive mixture. As diameter of CLPs increases, the transparency of the particles decreases, while the cost to produce them decreases.

In a further embodiment the colloidal lignin particles have a surface charge in the range of -100 – 50mV, suitably -50 – 40 mV, preferably -10 – 10 mV, measured by zeta potential, for example the surface charge of the lignin particles, measured by zeta-potential, can be between -100 – -10 mV, or -50 – -20mV. In an embodiment, the surface charge of the CLPs is controlled within these ranges thereby controlling how the particles aggregate and how they interact with other particles and molecules

In a still further embodiment the composition further comprises a plasticiser, preferably one or more plasticisers such as glycerol, starch or a polyol or oligosaccharide. The addition of plasticiser makes the composition more flexible and softer than compositions without plasticiser and glossier than compositions without plasticiser. In one embodiment, curing or cross-linking is slowed down by the addition of plasticiser, e.g. at room temperature.

As mentioned above, the composition is suitable for use in a surface coating. Thus, embodiments relate to a surface coating. In an embodiment the surface coating comprises a composition as described herein.

The use of lignin, particularly colloidal lignin particles, provides a major benefit as the epoxy-market is currently demanding more environmentally friendly and biocompatible solutions, and the specific use of colloidal lignin particles improves breathability and reduces the need for using volatile compounds/solvents within the product. Epoxy-based surface coatings/floorings can many times be damaged by humidity build-up under the coating. A breathable epoxy coating/flooring could, therefore, increase the product value immensely, while also increasing the demand for epoxy coatings and floorings as a whole. The coating is also considerably more resistant to wear and solvents than other natural and breathable coating solutions like wax or linseed oil. The breathability and abrasion resistance can also be utilized in textiles.

As mentioned above, the composition is suitable for use in an adhesive. Thus, embodiments relate to an adhesive. In an embodiment the adhesive comprises a composition as described herein.

In an embodiment the adhesive has the same formulation as the surface coating. In a further embodiment the adhesive has a different formulation as the surface coating. As an adhesive, embodiment provides excellent strength in both dry and wet conditions. The amount of the formulation needed to achieve the same results as currently used adhesives in e.g. plywood is very low. The invention differs from other existing solutions of the like by enabling easier spreading due to the better flow in water-dispersions that CLPs provide in comparison to raw lignin which enables the user to use less material with the same excellent result. Epoxy-polymerized CLPs additionally make excellent thermosets and can be prepared in water-based conditions without hazardous organic, acidic, or alkaline solvents. Epoxy compounds like glycerol diglycidyl ether or epoxidized lignin, both of which can be prepared from biobased sources would be excellent raw materials for the preparation of said biobased thermosets and would not increase the net carbon dioxide accumulation in the atmosphere.

Further embodiments relate to a method of manufacturing the composition. In an embodiment, the method for manufacturing a composition as described herein comprises the steps of providing colloidal lignin particles, providing an epoxy containing compound, and mixing the epoxy compound and the colloidal lignin particles to form a composition. In a preferred embodiment, the method comprises the further step of dispersing the colloidal lignin particles in water to form an aqueous dispersion.

In some embodiments it may be desirable to provide the composition with other components. Therefore, in an embodiment the method further comprises the step of adding an organic solvent. In a preferred embodiment the method comprises the further step of adding a plasticiser. In a suitable embodiment the method comprises the further step of adding one or more curing initiators or additives.

Further embodiments relate to a method of coating a surface. In an embodiment the method comprises the steps of applying a composition according to any embodiment described herein, obtainable by a method according to any embodiment described herein to a surface to be coated, and heating the coated surface to initiate a curing reaction.

In an embodiment a surface coating, comprising layer(s) of cured/hardened particles is/are formed on the surface which the coating is applied to. The coating is preferably highly resistant to external sources of stress, such as abrasion, heat, radiation, solvents, and aggressive chemicals. Suitably, the surface coating protects against corrosion and external sources of damage to the substrate, but can also be made more breathable. For example, in one embodiment breathability of the coating may be improved by incorporating CLPs with larger diameter into the composition, e.g. as the diameter of the CLPs increases they have a lower aspect ratio and are spaced further apart from one another allowing for air to move between the particles. In a further embodiment breathability of the coating may be improved by applying a thinner layer of coating. On even surfaces, the coating becomes smooth and shiny but can be made matte if desired. For example, in an embodiment the appearance of the coating is modified by the addition of colouring agents or pigments, e.g. in one embodiment the composition further comprises one or more pigments or one or more colouring agents. In a further embodiment the coating may be made matte by reducing the amount of the epoxy compound. Particularly, coatings with no plasticiser in the composition are more matte than coatings with plasticiser in the composition. In a suitable embodiment, glossiness of the coating is increased by increasing the thickness of the coating, e.g. a coating of more than 15 – 20 g/m² is glossier than a coating of less than 15 – 20 g/m².

In one embodiment the composition is applied to the surface with a brush, with a glass rod, with a steel rod and/or by spraying.

In a further embodiment the coated surface is heated using an oven, using radiation, using hot air, e.g. a device that blows warm or hot air, using a lamp and/or using a heating plate. In a preferred embodiment the coated surface is heated to a temperature up to 350° C., preferably 50 to 150° C.

In one embodiment the surface to be coated is prewetted in a prewetting step

In a further embodiment the surface to be coated is preheated in a preheating step, preferably to a temperature up to 350° C., typically not more than 75° C.

A further method of coating a surface is described in embodiments. In an embodiment the further method of coating a surface comprises the steps of applying colloidal lignin particles to a surface to be coated, and applying an epoxy compound to the surface to be coated in a separate step. In a particular embodiment the method further comprises adding one or more curing initiators and/or additives to the surface to be coated.

In one embodiment each component is applied to the surface with a brush, with a glass rod, with a steel rod and/or by spraying.

In a further embodiment the coated surface is heated using an oven, using radiation, using hot air and/or using a heating plate. In a preferred embodiment the coated surface is heated to a temperature up to 350° C., preferably 50 to 150° C.

In an embodiment the surface to be coated is prewetted in a prewetting step.

In a further embodiment the surface to be coated is preheated in a preheating step, particularly to a temperature up to 350° C., typically not more than 75° C.

In one embodiment, dry or aqueously dispersed CLPs are spread onto a surface. In the case of the CLPs being aqueously dispersed, they can be dried or kept wet/humid after being spread onto the surface. An epoxy compound is then spread onto the surface coated with CLPs. The components are then cured in hot/warm or ambient temperatures or in elevated radiation.

In an embodiment, the amount of epoxy and CLPs and thus their ratio can be controlled either by mass or volume of the added component. The ratio can optionally be left determined by the natural attraction of the epoxy compound towards CLPs. In that case, the epoxy compound can be applied by e.g. tapping the CLP-coated surface with a sponge or suitable sheet of textile material (or material of the like) containing some amount of the epoxy compound absorbed within it. The concentration of CLPs in the embodiment can be over 50 wt.% without any complications. The water amount could be so low that the particles are no longer in a dispersed state, or the particles can be completely dry. The dispersion may be as diluted as desired, although the application may become inconvenient if dispersion with concentrations below 1 wt.% are used.

The epoxy component may also be added first, in which case the epoxy compound is evenly stroked onto the surface. Then, dry or aqueously dispersed CLPs are added to the surface, whereupon the components are cured. Highly concentrated CLP dispersions (above 20 wt.%) work best if the CLPs are water dispersed.

Further embodiments relate to attaching a first substrate to a second substrate. In an embodiment a method of adhering a surface of a first substrate to a surface of a second substrate comprises the steps of applying a composition as described herein above obtainable by a method described hereinabove to coat a surface of a first substrate, pressing the coated surface of the first substrate with a surface of a second substrate, and heating the pressed material to a temperature up to 350 C.

In one embodiment the first substrate and the second substrate are of the same material. In a further embodiment the first substrate and the second substrate are of a different material. In a preferred embodiment either or both substrates are selected from the group consisting of wood, ceramics, textiles, plywood, veneer, plastics, metal and stone.

In an embodiment, two surfaces, one or both of which have been coated with an uncured mixture as described above, are cured in contact to cause covalent adhesion between the surfaces. The surfaces can then be pressed together to improve surface to surface contact, and consequently the adhesive strength between the surfaces.

In one embodiment, multiple layers of any material, e.g. wood, can be coated as previously described, stacked onto each other, and pressed using any type of device capable of providing sufficient force (> 0.1 kg/cm2) or by the weight of an object placed on the stack. If a device is used and is capable of providing heat, thus being a hot-press of some sort, the uncured coating between the layers of material can be cured rapidly while pressed. This embodiment can be used to produce plywood-type materials, layered composites, or materials or the like (FIG. 9). The embodiment can also be used to assemble products like varying types of furniture.

As the mixture of the components has a low viscosity, it is very easy to spread onto any surface. In an embodiment, the user can achieve a layered material with good adhesion between the layers with less adhesive compared to what can be achieved with existing commercial products.

The adhesive strength of adhered wooden surfaces can be higher than 10 MPa depending on the used mass, and the strength per adhesive spread (spread expressed in g/m2) is nevertheless higher than many commercial formaldehyde-based adhesives, while also being a tremendously safer option.

The use of CLPs as lignin-precursor for grafting epoxy groups onto lignin, and thus preparing epoxidized lignin, is a much safer option compared to currently existing strategies. The epoxidation of lignin usually requires the lignin to be dissolved in organic solvents or very alkaline aqueous solutions. By using CLPs, the lignin does not have to be dissolved in any flammable, hazardous, or corrosive medium, in contrast to many existing methods [24,25], making water dispersed CLPs a much safer option. The use of water dispersed CLPs enables better control of the reaction than achievable with other means. The resulting epoxidized lignin is water-soluble, therefore a safe option to use for any application where low toxicity and low hazardousness is desired.

Further embodiments relate to the stabilization of colloidal lignin particles. Embodiments provide a quick and simple way of preparing highly durable CLPs in a short timeframe using minimal effort and little energy,

In an embodiment there is provided a method of of stabilizing colloidal lignin particles comprising the steps of providing an aqueous dispersion of colloidal lignin particles, providing an epoxy compound, combining the aqueous dispersion with the epoxy compound, heating and stirring the mixture of the dispersion and the epoxy compound, and recovering cured CLPs. In a preferred embodiment, the concentration of CLPs is 10 wt.% or less thereby reducing the potential for aggregation. In a particular embodiment the mixture is heated at a temperature of 30° C. or more, e.g. at a temperature of 60° C., and stirred, e.g. using a hot plate and a magnetic stirrer. The time for heating and stirring is related to the temperature at which the mixture is stirred, e.g. at 60° C. two hours provides good cross-linking. As temperature increase, the time required for cross-linking decreases

It has been shown that the combination of the two components (CLPs and epoxy compound) can be used to stabilize the CLPs by cross-linking their surface. This can be used to increase the particle’s resistance towards alkaline, acidic and organic solvents. In a preferred embodiment the epoxy compound is water soluble. In a particular embodiment the epoxy is non-solid at room temperature.

In embodiments it is possible to add the epoxy compound to the aqueous dispersion of CLPs, however it is equally possible to add the aqueous dispersion of CLPs to the epoxy compound.

In such an embodiment it is preferable that the epoxy compound is dissolved or mixed in a solvent, preferably dissolved or mixed in water. In a further embodiment the solubility of the epoxy compound is increased with a volatile organic solvent prior to combining the epoxy compound with the aqueous dispersion of colloidal lignin particles, and/or optionally while the epoxy compound and the aqueous dispersion of CLPs are being combined.

In a further embodiment the mixing is carried out for a period of 10 minutes to 24 hours, preferably 30 minutes to 18 hours, suitably 1 hour to 12 hours, particularly 2 hours to 8 hours, typically 3 to 7 hours, advantageously 4 to 6 hours, optionally 5 hours.. In a preferred embodiment the mixing time depends on the temperature, e.g. some epoxy compounds, such as highly water soluble epoxy compounds like GDE, can cross-link particles to reach increased solvent resistance in less than one hour at room temperature. If heated, say at 60° C., it could be very much faster. In a particular embodiment the mixing time depends on the desired degree of cross-linking and the epoxy compound used, e.g. poorly water soluble epoxy compounds are very likely a lot slower to cross link or cure, Therefore in an embodiment the mixing time can suitably be up to 24 hours.

In one embodiment, excess epoxy compound is removed by the addition of an organic solvent capable of dissolving the epoxy-compound following removal of the supernatant by 2 - 10 rounds of supernatant exchange by centrifugation, or by ultra-filtration or dialysis. The resulting concentrated content of cured CLPs can be diluted or used as such for applications where increased stability is preferable.

In the embodiment, the concentration of the aqueous CLP dispersion is preferably not higher than 10%. Optionally, the CLP concentration can be as high as desired, but the amount of epoxy compound can be increased slowly to avoid the formation of interparticle links and in consequence the formation of aggregates. The concentration of organic solvents can, in that case, be increased along with the amount of epoxy compound, especially if the epoxy is non-water-soluble.

In a further embodiment there is provided cured lignin particles obtainable by a method of embodiments described herein.

Another aspect of the invention relates to the epoxidation of lignin using CLPs as a precursor. The result is a water soluble epoxidized lignin, which can be used as an epoxy compound together with CLPs in all other embodiments. The use of CLPs as a precursor instead of dissolved or suspended lignin alleviates the need for volatile solutions or alkaline reagents for the solubilization of lignin for the synthesis. This allows for a tremendously safer environment during the reaction and better control of the reaction itself. Currently used methods either dissolve lignin in alkaline solutions, which disables the user from controlling the reaction. To solve this, the use of organic solutions can be used to dissolve lignin. As the reaction is highly exothermic, this solution ultimately is more dangerous if the solvent is volatile and creates more hazardous waste products in any case. Another solution is fractionating lignin to only use the fraction that dissolves in epichlorohydrin, but the fractionation lowers the yield significantly, demands resources, and creates waste. Embodiments solve all the of the issues resulting in excellent conversion and therefore providing an excellent material for biobased epoxy resins, adhesive and coatings, and other applications, similar or otherwise.

The concentration of CLPs can vary, although high concentrations increase uncontrolled and undesired homopolymerization after the epoxidation reaction. In an embodiment the concentration of CLPs is in the range of 1 to 30 wt.%. In a preferred embodiment, the concentration of CLPs may be increased up to 40 wt.% at temperatures not exceeding room temperature, e.g. the temperature is maintained at room temperature or lower.

One embodiment thus relates to a method of epoxidising lignin using CLPs as a lignin precursor. In an embodiment the method comprises dispersing CLPs in water and heated under reflux, preferably heating to 65C under reflux, after which epichlorhydrin is added, preferably ca. 5 – 10 ml/g CLP, typically using a molar epichlorohydrin to lignin hydroxyl group ratio of 7:1 - 14:1 is added. As the epichlorohydrin to hydroxyl group ratio increase, the reaction time becomes faster. pH is adjusted to ca. 13, preferably in the range of 12 to 14, suitably 13, by the addition of a base, e.g. NaOH, to initiate the reaction. After the reaction has proceeded fully, the reaction is stopped by neutralizing the solution. In an embodiment the reaction is stopped by neutralizing with an acid, e.g. HCl. In a further embodiment the epoxidized lignin phase can be separated from the other phases by various methods, such as rotary evaporation, phase-separation by funnels and/or filtering. Thus, in a further embodiment the method comprises the further stop of recovering epoxidised lignin.

By means of embodiments, epoxidised lignin is recovered. Thus one embodiment provides epoxidised lignin obtainable by methods of the embodiments described herein.

As mentioned above further embodiments relate to a thermoset. In an embodiment the thermoset is formed from a composition as described hereinabove, e.g. the composition comprises an epoxy compound and colloidal lignin particles. In a preferred embodiment the thermoset is formed from an epoxidised lignin, preferably an epoxidised lignin as described herein and colloidal lignin particles.

A method of forming a thermoset is also described. In an embodiment the method comprises the steps of providing a dispersion of colloidal lignin particles, providing an epoxy compound, mixing the dispersion of colloidal lignin particles and the epoxy compound in a centrifuge, recovering a supernatant, and heating the supernatant at a temperature in the range of 40 – 350 C.

The composition used in forming the thermoset is in an embodiment provided by any of the methods described herein. The epoxy compound used in forming the thermoset is preferably any epoxy compound, suitably an epoxy compound described herein, particularly epoxidised lignin described above, obtainable by the method described above.

Typically, CLPs are mixed with an epoxy compound. The mixture is then preferably compacted using centrifugation and then heated to cure the mixture. The use of CLPs enables the formation of thermosets in a water-based setting, which is both safer and easier than known methods. The resulting thermosets have the same general properties as the surface coating, described above. The mechanical properties and flexibility of the thermoset can be varied by varying the properties of the epoxy compound or by addition of plasticisers.

### EXAMPLES

### Example 1. Preparation of Highly or Fully Biobased Surface Coating Using Glycerol Diglycidyl Ether

The aim of this example is to present some methods and conditions for preparing a surface coating using glycerol diglycidyl ether (GDE) and CLPs. Aqueously dispersed CLPs are prepared and concentrated/diluted to 25 wt.% by centrifugation/addition of deionized water. The CLP dispersion is optionally diluted so that the concentration after the addition of GDE is between 10.1 - 18.6 wt.%, depending on the desired thickness of the coating and the number of layers. The GDE is combined with the CLP dispersion and mixed thoroughly for at least one minute. A desired amount of the mixture is then spread onto the desired surface. If the surface is non-water absorbing (e.g. metal), it may be heated up to 350° C., but preferably not more than 75° C., to make the spreading easier by removing excess moisture while not initiating the curing too quickly. If the surface is water absorbing (e.g. wood), it may be pre-wetted to a desired degree to improve spreadability. The mixture can be spread on the surface using any suitable tool, such as a brush, a glass or steel rod, or by spraying. The coated surface is then heated by e.g. using an oven, radiation, hot air, or a heating plate (whereas the surface would be heated from below) to initiate the curing reaction. The surface’s temperature may be as high as 350° C., but preferably between 50 – 150° C. When fully cured, the surface can be coated with additional layers by repeating the procedure. The duration of the curing reaction varies depending on the temperature. In 105° C., the curing takes 1h - 1h 30 min.

FIG. 1 presents AFM images of thick coatings in various GDE/CLP ratios and FIG. 2 shows SEM images of a thick cured mixture at the GDE/CLP ratio 0.65 g/g. FIG. 3 presents SEM images of a cured mixture on wood.

### Example 2. The Effect of the Epoxy/CLP Ratio on Abrasion Resistance

This example aims to present the effect of various GDE/CLP ratios on the coating’s resistance towards abrasion. A 20 wt.%. CLP dispersion is prepared according to example 1. The dispersion is then divided into five different samples. GDE is added to make the GDE/CLP ratio in the samples 0.90, 0.78, 0.65, 0.52 and 0.39 g/g. The mixture is stirred for 2 - 5 minutes, while steel plates are heated to 70° C. The mixtures are then spread onto separate steel plates using a glass rod, while the plates are heated from below. The coated plates are then cured for 1 h in an oven at 105° C. The samples are conditioned at 23° C. and 50%RH for 24 h as preparation for the abrasion resistance evaluation. The abrasion resistance of the samples is evaluated following the ASTM D-4060 method using CS-10 abrasive wheels and a load of 1000 g. FIG. 5 presents the mass loss per 1000 cycles of abrasion. All samples show moderate abrasive resistance compared to commercially available surface coatings, although the GDE/CLP ratio 0.52 g/g show significantly stronger abrasive resistance compared to the others. The reason for the poor abrasive resistance in the epoxy/CLP ratios above 0.52 g/g may be that unreacted epoxy work as a softener. It may also be that excess epoxy forms small cavities within the cured structure, which collapse when abraded. The epoxy may react, but cavities could remain nevertheless.

### Example 3. The Effect of the Curing Time

This example aims to present the effect of the curing time on the mechanical properties of the surface coating. A 20 wt.% CLP dispersion is prepared as in example 1. The dispersion is divided into five different samples and GDE is added to make the GDE/CLP ratio 0.52 g/g. The mixture is stirred for 2 - 5 minutes, while steel plates are heated to 70° C. The mixtures are then spread onto separate steel plates using a glass rod, while the plates are heated from below. The coated plates are then cured in 20, 40, 60, 80, and 100 minutes in an oven at 105° C. The coated plates are then conditioned at 23° C. and 50 %RH for 24 h. The abrasion resistance of the samples is evaluated following the ASTM D-4060 method using CS-10 abrasive wheels and a load of 1000 g. FIG. 6 presents the mass loss per 1000 cycles of abrasion for the different samples. The results show that the mixture needs 60 minutes to cure sufficiently for these specific samples, although there are some benefits to increase the curing time to 80 minutes. Surprisingly, curing 100 minutes decreases the coating’s abrasion resistance compared to 80 minutes. It may be that prolonged curing in high temperatures induces undesired oxidation reactions, which may increase brittleness. It should however be noted, that sample thickness and coating thickness will affect the optimum curing time, and the curing time may therefore have to be altered in different cases.

FTIR results of mixture cured for 0, 5, 10, 20, 30, 40, 50, 60, 70, 80, 90, and 100 minutes show that measurable presence of uncured epoxy disappears at ca. 40 minutes of curing based on the epoxy peak at wavenumber 910 cm-1, regardless of the epoxy/CLP ratio.

### Example 4. The Effect of Surface Thickness and Epoxy/CLP Ratio on Breathability

This example aims to show how the thickness of the coating affects the breathability. Pinewood samples measured 6.2 x 6.3 cm were moist with deionized water and coated with mixtures prepared as described in example 1. Three sample-series with epoxy/CLP ratios of 0.65, 0.52, and 0.39 g/g and coating thicknesses 12.4, 8.9 and, 6.9 g(CLP)/m2 were prepared. All samples were cured for 1.5 h.

The breathability of all samples was evaluated using the NORDTEST method [26]. Briefly, all sides of the samples, except the coated surfaces, were covered with aluminium tape and placed in a Rumed 4201 (Rubarth Apparate GmbH, Germany) climactic chamber set to cycle between 33 (16 h) and 75 (8 h) %RH and 23° C. The samples were conditioned for 48 h in the test setting before starting the test. Then, the samples were weighed 5 - 10 minutes before each change in humidity for three days. FIG. 4 presents the average mass change in all samples and in four commercially available references, which were prepared according to their respectively provided instructions. The results show that all the samples coated with the invention possess excellent breathability compared to commercial references. Of the evaluated GDE/CLP ratios, 0.52 g/g breathes somewhat worse on average regardless of thickness compared to the others, reaching values of about 0.9 g/(m2 %RH), while the other ratios reached values close to 1 g/(m2 %RH), which is the same as the moisture buffer value of uncoated wood. The value is especially impressive when considering the fact that the coatings are epoxy-based. The epoxy reference only reached about 0.28 g/(m2 %RH).

### Example 5. The Effect of Surface Thickness and Epoxy/CLP Ratio on Water Repellency

The coating rendered samples both water repellent (high water contact angle) and water resistant (very low water absorbance). Pinewood samples were prepared as described in example 4. The water adsorption and hydrophobicity were measured using a ThetaFlex tensiometer device (Biolin Scientific, Sweden). A drop of 4 µl water was placed onto the surface. The volume of the drop was monitored for 3 minutes, and the water-absorption was observed during this time. The water contact angle was obtained one minute after the drop was placed onto the surface. FIG. 7 presents the contact angle of the samples. The contact angles of the samples with GDE/CLP ratios 0.65 and 0.52 g/g are classified as hydrophobic, as both coatings reach values of over 90 °, although all samples coated with the GDE/CLP ratio 0.52 g/g reach values over 100 °. The thinner coatings in all cases have a higher contact angle, likely due to a higher surface roughness. The samples coated with the 0.52 g/g GDE/CLP ratio with the thickness 6.9 g(CLP)/m2 show especially high hydrophobicity, with a contact angle of almost 120 °. Compared to the commercial references, both the ratios 0.65 and 0.52 g/g show superior hydrophobicity, and the ratio 0.39 g/g show similar hydrophobicity to the references.

The water absorbance was faster for the 0.39 g/g epoxy/CLP ratio. The thinnest layers of that ratio however, absorbed water similarly to that of the samples coated using the GDE/CLP ratios 0.65 and 0.52 g/g. The reason for this is unclear but is likely due to optimal surface roughness in thinner layers of coating, which would fit with the observed trends of the contact angles. The GDE/CLP ratios 0.65 and 0.52 g/g had a relatively slow water absorption, similar to that of the commercial oil and lacquer. The thinnest layer of the GDE/CLP ratio 0.52 g/g, which was especially water repellent, competed with the commercial epoxy coating, as both seemed to not absorb water significantly during the three minutes.

### Example 6. The Effect of Surface Thickness and epoxy/CLP Ratio on Stain Resistance

Pinewood samples were prepared as described in Example 4. The coated surfaces were then stained with acetone (2x 45 µl), red wine (45 µl), and coffee (45 µl). The droplets were allowed to remain on the surfaces for one minute before being wiped away. FIG. 8 shows changes in appearance before and after staining a 0.65 g/g GDE/CLP ratio with a thickness of 12.4 g CLP/m2. Both GDE/CLP ratios 0.65 and 0.52 g/g show good resistance towards coloured stains and acetone, as the coating shows no, or very little effect or damage by the stains. The commercial coatings were visibly equally resistant. The GDE/CLP ratio 0.39 g/g however, is clearly damaged by the acetone and changes appearance to a darker colour on the exposed area. The wine and coffee stains, on the other hand, do not show evidence of sticking.

### Example 7. Epoxidation of Lignin Using CLP as a Precursor

This example aims to present a possible way to use CLPs as lignin-vector for epoxidation in water-based systems. The particle size of the CLPs used in this experiment was 600 - 900 nm in diameter.

4 g 50 wt.% CLP dispersion is weighted into a round flask and diluted to 10 - 15 wt.% by adding deionized water. The dispersion was then heated to 65° C. under reflux while stirred at 750 rpm. Then, 14 ml epichlorohydrin was added. The mixture was heated for 5 minutes. Then, 17 ml 1 M NaOH was carefully added by dropping portions of 2 ml at a time with a 1 - 2 minutes between each portion. The reaction was allowed to proceed for 30 minutes, after which it was stopped by the addition of 10 ml 1 M HCl, during which three-phases appeared, a dark gel-like phase, containing most of the epoxidized lignin, a light brown aqueous phase, containing mostly non-reacted lignin and a dark organic liquid phase containing mostly excess epichlorohydrin. The gel-like phase was isolated, rotary evaporated and re-dissolved in deionized water. The epoxidized lignin (EL) was analysed by FTIR and P-NMR (preparation of lignin for P-NMR described by Sipponen et al. [27]). FTIR measurements showed a clear epoxy peak at 910 cm-1 and no carbon-chloride peak between 850 - 550 cm-1, suggesting that the epoxy peak did not derive from free, unreacted epichlorohydrin. P-NMR measurements showed a hydroxyl-to-epoxy conversion of 94.6%.

### Example 8. Adhesive Properties of Epoxy-Cured CLPs

This example aims to present methods for and the possibilities of using the invention as an adhesive for various surfaces.

A mixture of GDE and CLPs is prepared as in example 1. The preferred ratio of the CLPs and the used epoxy in general should be such that the molar ratio of hydroxyl-and epoxy-groups in the CLPs and the epoxy compound respectively is close to 1 mol/mol. The mixture is stirred and a desired amount, preferably between 12.4 - 6.9 g(CLP)/m2 is spread onto a surface. Then, another surface is put into contact with the former. This surface can be dry or also coated with an uncured or cured mixture of CLPs and epoxy. The surfaces are then pressed together, preferably at 1 - 10 kg/cm2. The speed of curing can be altered by the addition of curing initiators, such as di-, tri- or tetra-ethylenetetramine, or by using a hot press set to 130 - 200° C. while pressing. Multiple layers can be combined and pressed simultaneously. FIG. 9 shows a piece of strong plywood prepared by pressing coated layers at 160° C. with a force of 7 kg/cm2 for 10 minutes.

The adhesive strength of combined wooden surfaces is dependent on the amount of mixture used. For example, a combination of epoxidized lignin (example 7) and CLPs with a molar ratio of 1:1 with a respective wet and dry glue spread of ca. 155 g/m2 and 5.4 g/m2 cured by hot-press at 160° C. and 7 kg/cm2 for 10 minutes resulted in adhesive strengths of 2.674 ± 0.196 MPa. The very low dry glue spread used in this test demonstrates the excellent adhesive strength achieved using very little adhesive mass. Higher amounts of adhesive logically yield extreme strength. For example, a combination of GDE and CLPs in the ratio 0.65 g/g with a respective wet and dry glue spread of 413.0 and 61.0 g/m2 cured by hot-press at 160° C. and 7 kg/cm2 for 10 minutes resulted in an average adhesive strength of 7.102 ± 0.686 MPa, which is extremely high, but the glue spread is also relatively high. Using the same preparation method and respective wet and dry glue spreads of 206.9 and 27.33 g/m2 resulted in an average adhesive strength of 4.11 ± 0.814 MPa, which is very high considering the glue spread. Commercial plywood should reach an adhesive strength of 2.344 MPa according to the ASTM-D4960 specifications for urea-formaldehyde-type adhesives, and usual wet glue spreads are around 150 g/m2 [28,29]. The invention reaches these criteria with a very low glue spread.

### Example 9. Preparation of Moldable Thermosets From CLPs and Epoxy

A dispersion of CLPs with a concentration between 10 - 50 wt.%, or as high as achievable while the CLPs are still in a dispersed state, is combined with an epoxy compound in epoxy/hydroxyl molar ratios between 1.5 - 0.6 mol/mol, preferably between 1 - 0.8 mol/mol, and other desired additives and stirred thoroughly. Then, the mixture is put into a metal Eppendorf-like tube and centrifuged at 5 000 - 20 000 rpm for 10 - 40 minutes. The supernatant is removed from the tube, which is then heated at 40 - 350° C., preferably between 60 - 100° C., until fully cured. The resulting material is a homopolymerized lignin thermoset. The curing temperature can be lowered by the addition of curing initiators, such as di- tri, or tetra- ethylenetetramine, as additives. The tube which was mentioned can be exchanged by a mould of desired form and put inside a holding station suitable for the used centrifuge to create thermosets with desired shapes. Alternatively, the centrifugation can take place at low temperatures, preferably between -10 - 4° C., whereafter the supernatant is removed, and the content of the tube is pressed into a desired mould, where it is cured at a temperature between 40 - 200° C.

Further embodiments are disclosed in the following numbered clauses:

1. Method for preparing an epoxy-cured lignin-particle-based surface coating possessing resistance against abrasion and various types of chemical attack, excellent breathability, UV-protective, and a high portion of completely safe and biobased material by
i. combining dry or dispersed CLPs with an epoxy compound and optionally other curing initiators or additives and spreading the mixture onto a surface
ii. spreading CLPs and optionally other curing initiators or additives and epoxy separately on a surface

2. The method according to clause 1 where the lignin particles are spherical, with a diameter of 10 - 1000 nm, a surface charge of -100 - -10 mV, usually -50 - -10, measured by zeta-potential, and do not sediment significantly in 24 hours when dispersed in deionized water in 25° C.

3. The method according to the previous clauses where the lignin particles are lignin hybrid particles, in other words, particles of two or multiple components of which lignin is the main component, and the others are substances which can form spherical particles together with lignin, such as a fatty-acid, protein, or a polymer of other sorts.

4. The method according to the previous clauses where the lignin particles are infused with significant concentrations of ionic or non-ionic metal, like silver, to gain antimicrobial properties.

5. The method according to the proceeding clauses, where the lignin particles are dispersed in water, moist, or completely dry.

6. The method according to clause 1 where the epoxy is any molecule or polymer with at least two epoxide-groups on it.

7. The method according to the previous clauses where the combined components on the desired surface are cured in elevated temperatures up to 350° C., preferably 50 -150° C.

8. The method according to the previous clauses where the combined components are cured using radiation in the form of visible or ultraviolet or infrared light in intensities up to 100 000 W/m².

9. The method according to clauses 1 - 6 where the curing reaction proceeds to some degree or fully in room temperature and standard pressure (25° C., 101 kPa) made possible by reactive curing initiators, such as, but not limited to, di-, tri- or tetraethylenetetramine .

10. The method according to the previous clauses where the conditions which have been presented in previous clauses are combined and/or altered during the curing reaction.

11. The method according to the previous clauses where the material onto which the coating is applied can be any bendable, flexible, or rigid material, e.g. wood, textiles, metal, glass, any type of solid plastic, or any type of solid composite.

### Lignin Particle Adhesive

12. A method for preparing durable adhesives of epoxy-compounds and CLPs, compromising excellent and easy spreadability, extreme strength in wet and dry conditions, and low hazardousness compared to existing solutions.

13. The method according to clause 12, which begins by fully or partly coating one or both sides of one or more surfaces of separate substrates with the mixture according to clause 1, and then proceeds by pressing
i. two surfaces of the same or different material, one or both of which are coated
ii. multiple sheets of one or a combination of desired materials, of which one or both sides are coated with uncured components according to clause 1, thereby resulting in a solid multilayered material, like plywood if only sheets of wood are combined, or multilayered composites if sheets of several different materials are combined.

14. The method according to clause 13 where the pressing can be done in any condition which promotes curing and at any force sufficient for adhesion, where the conditions for the used materials and curing process described for clause 1 by clauses 2 - 11 apply.

### Water-Soluble Lignin-Based Epoxy Resin

15. A method for preparing water-soluble epoxidized lignin in high yields and low waste production by using water dispersed CLPs as a lignin precursor.

16. The method according to clause 15 where the lignin particles are in accordance with clause 2 and are dispersed in water.

17. The method according to clauses 15 and 16 where the temperature is between 40 -100° C. and the beaker enables the use of a refluxer and a refluxer is used.

18. The method according to clauses from clause 15 forward, where epichlorohydrin is added to the lignin dispersion before or after the desired temperature is reached.

19. The method according to clauses from clause 18 forward, where the amount of added epichlorohydrin makes the molar ratio of epichlorohydrin to lignin-hydroxyl-groups become 0.5:1 - 20:1, preferably between 7:1 - 15:1.

20. The method according to clauses 18 forward where sodium hydroxide or a similar water-soluble alkaline substance is added after the addition of epichlorohydrin so that the pH becomes between 11 - 14, preferably 13.5 - 14.

21. The method according to clauses from clause 15 forward where an acid, such as chloric acid or sulfuric acid is added 0.5 - 5 h, preferably 0.5 - 2 h, after the addition of the sodium hydroxide to set the pH between 5 - 9, preferably 6 - 8 to stop the reaction.

22. The method according to clauses from clause 15 forward where the liquid phase is separated from the solid suspended phase using a filter and/or a suitable type of separation funnel, and the excess epichlorohydrin in the liquid phase is removed by rotary evaporation in reduced pressure (1 - 100 mbar in 40 - 70° C.) or flash evaporation.

### Lignin Particle Thermoset

23. A method for the preparation of epoxy-cured lignin-particle-based thermosets, compromising resilience against chemical attacks and mechanical stress.

24. The method according to claim 23 where the conditions for the epoxy compound and lignin particles are in accordance with claims 2 - 6 or the epoxy compound is epoxidized lignin prepared according to claims 15 - 22.

25. The method according to claims from 23 forward where the lignin particles are combined with the epoxy compound and centrifuged in a tube-like beaker for at 5 000 - 15 000 rpm for 10 - 40 minutes at -10 - 60° C.

26. The method according to claims from 23 forward where the centrifuged content is cured in accordance with claims 7 - 10.

27. The method according to claims from 23 - 24 where the lignin particles and the epoxy compound are placed within a mold and cured in accordance with the conditions described in claims 7 - 9.

### Fully Lignin-Based Surface Coatings, Adhesives, and Thermosets Using Epoxidized Lignin

28. A highly or fully lignin-based surface coating, adhesive, and thermoset, functioning according to claims 1,12, and 23 respectively, using the epoxidized lignin prepared according to claims 15 - 22 as epoxy compound according to claims 1 - 14.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in coatings e.g. in the preparation of 100% biobased breathable floor coatings. Further embodiments can be used in the preparation of 100% biobased plywoods or in the preparation of plywoods.

### CITATION LIST

1. Jin FL, Li X, Park SJ. Synthesis and application of epoxy resins: A review. Vol. 29, Journal of Industrial and Engineering Chemistry. 2015. p. 1-11.

2. Resnik DB, Elliott KC. Bisphenol a and risk management ethics. Bioethics. 2015;29(3):182-9.

3. Kang JH, Aasi D, Katayama Y. Bisphenol A in the aquatic environment and its endocrine-disruptive effects on aquatic organisms. Vol. 37, Critical Reviews in Toxicology. 2007. p. 607-25.

4. Michalowicz J. Bisphenol A - Sources, toxicity and biotransformation. Vol. 37, Environmental Toxicology and Pharmacology. 2014. p. 738-58.

5. Moon MK. Concern about the safety of bisphenol a substitutes. Vol. 43, Diabetes and Metabolism Journal. 2019. p. 46-8.

6. Vandenberg LN, Chahoud I, Heindel JJ, Padmanabhan V, Paumgartten FJR, Schoenfelder G. Urinary, circulating, and tissue biomonitoring studies indicate widespread exposure to bisphenol A. Vol. 118, Environmental Health Perspectives. 2010. p. 1055-70.

7. European Commission. Bisphenol A, Q&A. In: Q&A [Internet]. 2018. Available from: https://ec.europa.eu/food/sites/food/files/safety/docs/cs_fcm_qa_bisphenol_a.pdf

8. Zubkova ZA, Stetsyuk MF, Georgitsa TA. Modified amine curing agents of epoxy resins and materials on their basis. Polym Sci - Ser D. 2010;3(3):177-80.

9. Bourne LB, Milner FJ, Alberman KB. Health problems of epoxy resins and amine-curing agents. Br J Ind Med. 1959;16(2):81-97.

10. Sun XS, Li C. Biobased epoxy monomers, compositions and uses thereof. WO2017096187 (A1), 2016.

11. Li C, Ye S, Zhang T, Ma D, Ji H, Zhong C, et al. Bio-based epoxy resin composition and application thereof in preparing epoxy resin film. China; CN109467677 (A), 2019.

12. Zhang T, Ye S, Li C, Ma D, Ji H, Zhong C, et al. Preparation process of biobased epoxy resin, product and application. China; CN109503644 (A), 2019.

13. Nannan X, Wu Q, Shao W, Kong F. A kind of water-resistant bio-based adhesive and preparation method thereof. China; CN109181612 (A), 2018.

14. H G. Biobased Lignin Adhesives for Plywood Applications and Manufacturing of Improved Wood-based Products. United States of America; US2015329753 (A1), 2015.

15. Wang W, Liu P, Xing Q. Biological-based ultraviolet protection and weathering-resistant core-shell micro-nanoparticles. China; CN109701462 (A), 2018.

16. Zafar A, Areskogh D. A composition comprising lignin and epoxy compound for coating and method for manufacturing thereof and use thereof. WO2015044893 (A1), 2014.

17. Bode D, Wilson P, Craun Gary P. Lignin based coating compositions. South Korea; KR20150097554 (A), 2013.

18. Phanopoulos C, Pans G, Teboul M, Lima Garcia J. Incorporation of lignin in polyurethane products. United States of America; US2018312625 (A1), 2016.

19. Edye LA, Tietz AJ. Lignin-based waterproof coating. United States of America; US10544545 (B2), 2014.

20. Adam GA. Water based lignin epoxy resins, methods of using and making the same. WO2014021887 (A1), 2012.

21. Lintinen K, Bangalore Ashok RP, Leskinen T, Xiao Y, Osterberg M, Kostiainen M, et al. Aqueous lignin dispersions and methods of preparing the same. Finland; WO2019081819 (A1), 2018.

22. Sipponen MH, Lange H, Crestini C, Henn A, Österberg M. Lignin for Nano- and Microscaled Carrier Systems: Applications, Trends, and Challenges. ChemSusChem. 2019;12(10):2039-54.

23. Figueiredo P, Lintinen K, Kiriazis A, Hynninen V, Liu Z, Bauleth-Ramos T, et al. In vitro evaluation of biodegradable lignin-based nanoparticles for drug delivery and enhanced antiproliferation effect in cancer cells. Biomaterials. 2017;121:97-108.

24. Sasaki C, Wanaka M, Takagi H, Tamura S, Asada C, Nakamura Y. Evaluation of epoxy resins synthesized from steam-exploded bamboo lignin. Ind Crops Prod. 2013;43(1):757-61.

25. Malutan T, Nicu R, Popa VI. Lignin modification by epoxidation. BioResources. 2008;3(4):1371-6.

26. Rode C, Peuhkuri R, Mortensen LH, Hansen KK, Time B, Gustavsen A, et al. Moisture buffering of building materials, Report BYG-DTU R-126. 2005;78.

27. Sipponen MH, Smyth M, Leskinen T, Johansson LS, Osterberg M. All-lignin approach to prepare cationic colloidal lignin particles: Stabilization of durable Pickering emulsions. Green Chem. 2017;19(24):5831-40.

28. Adhikari BB, Appadu P, Kislitsin V, Chae M, Choi P, Bressler DC. Enhancing the adhesive strength of a plywood adhesive developed from hydrolyzed specified risk materials. Polymers (Basel). 2016;8(8).

29. Bekhta P, Ortynska G, Sedliacik J. Svojstva modificiranoga fenol-formaldehidnog ljepila za furnirske ploče proizvedene od furnira s visokim sadržajem vode. Drv Ind. 2015;65(4):293-301.

1. A composition comprising colloidal lignin particles and an epoxy compound.

2. The composition according to claim 1, wherein the colloidal lignin particles are dispersed in an aqueous dispersion.

3. The composition according to claim 1 or 2, wherein the aqueous dispersion has a concentration of colloidal lignin particles up to 50 wt. %.

4. The composition according to any of claims 1 to 3, wherein the aqueous dispersion has a concentration of colloidal lignin particles in the range of 5 to 20 wt. %.

5. The composition according to any of the preceding claims further comprising one or more organic solvents, suitably organic volatile solvents.

6. The composition according to any of the preceding claims, further comprising one or more organic solvents selected from the group consisting of ethanol, tetrahydrofuran and acetone.

7. The composition according to any of the preceding claims, wherein water comprises more than 70 vol% in relation to the one or more organic solvents.

8. The composition according to any of the preceding claims, wherein the epoxy compound is a hydrophilic compound.

9. The composition according to any of the preceding claims, wherein the epoxy compound is glycerol diglycidyl ether.

10. The composition according to any of the preceding claims having a molar epoxy/colloidal lignin particle ratio of up to 1.5:1.

11. The composition according to any of the preceding claims having a molar ratio of epoxy group to hydroxyl groups between 1.5:1 - 0.2:1, preferably 1:1 - 0.6:1.

12. The composition according to any of the preceding claims having a concentration of colloidal lignin particles of 10 - 20 wt. % of the composition.

13. The composition according to any of the preceding claims having a concentration of colloidal lignin particles of 30 wt.% or more of the composition, typically in the range of 50 to 80 wt. %of the composition, preferably 70 wt. % of the composition.

14. The composition according to any of the preceding claims, further comprising one or more curing initiators or additives.

15. The composition according to any of the preceding claims, wherein the colloidal lignin particles are spherical.

16. The composition according to any of the preceding claims, wherein the colloidal lignin particles have a diameter in the range of 10 - 2000 nm, preferably 100 - 1500 nm, suitably 500 - 1000 nm.

17. The composition according to any of the preceding claims, wherein the colloidal lignin particles have a surface charge in the range of -100 - 50mV, suitably -50 - 40 mV, preferably -10 - 10 mV, measured by zeta potential.

18. The composition according to any of the preceding claims further comprising a plasticiser.

19. A surface coating comprising the composition of any of claims 1 to 18.

20. An adhesive comprising the composition of any of claims 1 to 18.

21. A method for manufacturing a composition according to any of the preceding claims comprising the steps of
• providing colloidal lignin particles,
• providing an epoxy containing compound, and
• mixing the epoxy compound and the colloidal lignin particles to form a composition.

22. The method according to claim 21 comprising the further step of dispersing the colloidal lignin particles in water to form an aqueous dispersion.

23. The method according to claim 21 or 22 comprising the further step of adding an organic solvent.

24. The method according to any of claims claim 21 to 23 comprising the further step of adding a plasticiser.

25. The method according to any of claims 21 to 24 comprising the further step of adding one or more curing initiators or additives.

26. A method of coating a surface comprising the steps of
• applying a composition according to any of claims 1 to 19, obtainable by a method according to any of claims 21 to 25 to a surface to be coated,
• heating the coated surface to initiate a curing reaction.

27. The method according to claim 25 or 26, wherein the composition is applied to the surface with a brush, with a glass rod, with a steel rod and/or by spraying.

28. The method according to any of claims 25 to 27, wherein the coated surface is heated using an oven, using radiation, using hot air and/or using a heating plate.

29. The method according to any of claims 25 to 28, wherein the coated surface is heated to a temperature up to 350C, preferably 50 to 150C.

30. The method according to any of claims 25 to 29 comprising the step of prewetting the surface to be coated.

31. The method according to any of claims 25 to 30, comprising the step of preheating the surface to be coated, particularly to a temperature up to 350C, typically not more than 75C.

32. A method of coating a surface comprising the steps of
• applying colloidal lignin particles to a surface to be coated, and
• applying an epoxy compound to the surface to be coated in a separate step.

33. The method according to claim 32, further comprising adding one or more curing initiators and/or additives to the surface to be coated.

34. The method according to claim 32 or 33, wherein each component is applied to the surface with a brush, with a glass rod, with a steel rod and/or by spraying.

35. The method according to any of claims 32 to 34, wherein the coated surface is heated using an oven, using radiation, using hot air and/or using a heating plate.

36. The method according to any of claims 32 to 35, wherein the coated surface is heated to a temperature up to 350C, preferably 50 to 150C.

37. The method according to any of claims 32 to 36 comprising the step of prewetting the surface to be coated.

38. The method according to any of claims 32 to 37, comprising the step of preheating the surface to be coated, particularly to a temperature up to 350C, typically not more than 75C.

39. A method of adhering a surface of a first substrate to a surface of a second substrate comprising the steps of
• applying a composition according to any of claims 1 to 20 obtainable by a method according to any of claims 21 to 25 to coat a surface of a first substrate,
• pressing the coated surface of the first substrate with a surface of a second substrate,
• heating the pressed material to a temperature up to 350C.

40. The method according to claim 39, wherein the first substrate and the second substrate are of the same material.

41. The method according to claim 39, wherein the first substrate and the second substrate are of a different material.

42. A method of stabilizing colloidal lignin particles comprising the steps of
• providing an aqueous dispersion of colloidal lignin particles,
• providing an epoxy compound,
• combining the aqueous dispersion with the epoxy compound,
• heating and stirring the dispersion, and
• recovering cured CLPs.

43. The method according to claim 42, wherein the epoxy compound is dissolved or mixed in a solvent, preferably dissolved or mixed in water.

44. The method according to claim 42 or 43, wherein the solubility of the epoxy compound is increased with a volatile organic solvent prior to combining the epoxy compound with the aqueous dispersion of colloidal lignin particles.

45. The method according to any of claims 42 to 44, wherein the mixing is carried out for a period of 10 minutes to 24 hours, preferably 30 minutes to 18 hours, suitably 1 hour to 12 hours, particularly 2 hours to 8 hours, typically 3 to 7 hours, advantageously 4 to 6 hours, optionally 5 hours.

46. Cured lignin particles obtainable buy a method according to any of claims 42 to 45.

47. A method of epoxidising lignin using CLPs as a lignin precursor, said method comprising the steps of
• dispersing CLPs in water
• heating under reflux,
• adding epichlorhydrin is added,
• adjusting pH to 12 to 14, by the addition of a base, to initiate the reaction, and
• neutralizing the solution with an acid to stop the reaction.

48. The method according to claim 47, wherein the dispersion is heated under reflux to 65C.

49. The method according to claim 47 or 48, epihydrochlorin is added in an amount of 5 -10 ml/g CLP, typically using a molar epichlorohydrin to lignin hydroxyl group ratio of 7:1 - 14:1.

50. The method according to any of claims 47 to 49, wherein the pH is adjusted with NaOH in the pH adjusting step.

51. The method according to any of claims 47 to 50, wherein the pH is adjusted to ca. 13 in the pH adjusting step.

52. The method according to any of claims 47 to 51, wherein the reaction is neutralized with HC1 to stop the reaction.

53. The method according to any of claims 47 to 52, further comprising recovering epoxidised lignin.

54. Epoxidised lignin obtainable by a method according to any of claims 47 to 53.

55. A thermoset formed from a composition according to any of claims 1 to 18.

56. A thermoset formed from an epoxidised lignin according to claim 54 and colloidal lignin particles.

57. A method of forming a thermoset comprising the steps of
• providing a dispersion of colloidal lignin particles
• providing an epoxy compound,
• mixing the dispersion of colloidal lignin particles and the epoxy compound in a centrifuge,
• recovering a supernatant, and
• heating the supernatant at a temperature in the range of 40 - 350 C.

58. A thermoset according to claim 55 or 56 obtainable by a method according to claim 57.
